(19) United States
(12) Patent Application Publication
(10) Pub. No.: US 2022/0056243 A1
(43) Pub. Date: Feb. 24, 2022

(54) VIBRATION ISOLATION RUBBER COMPOSITION AND VIBRATION ISOLATION RUBBER MEMBER

(71) Applicant: Sumitomo Riko Company Limited, Aichi (JP)

(72) Inventors: Masashi OKAHISA, Aichi (JP); Seiji KASAI, Aichi (JP); Hiroaki NAIKI, Aichi (JP)

(73) Assignee: Sumitomo Riko Company Limited, Aichi (JP)

(21) Appl. No.: 17/519,535

(22) Filed: Nov. 4, 2021

Related U.S. Application Data
(63) Continuation of application No. PCT/JP2021/000949, filed on Jan. 14, 2021.

(30) Foreign Application Priority Data
Jan. 30, 2020 (JP) 2020-013806

(51) Int. Cl. C08L 7/00; C08K 3/06; C08K 3/22; C08K 3/04; C08K 5/25; C08K 5/098; C08F 220/28; C08F 220/30

(52) U.S. Cl. CPC C08L 7/00; C08K 3/06; C08K 3/22; C08K 3/04; C08K 2003/2296; C08K 5/098; C08F 220/286; C08F 220/301; C08K 5/25

(57) ABSTRACT

A vibration isolation rubber composition containing the following components (B) to (E) together with a polymer made of a component (A) below is provided. Accordingly, it is possible to achieve both heat resistance and a low dynamic-to-static modulus ratio at a high level without impairing durability. In the vibration isolation rubber composition, (A) is a diene rubber, (B) is a filler, (C) is a dihydrazide compound, (D) is any one of a (meth)acrylic acid monomer, zinc oxide, and zinc (meth)acrylate, and (E) is a sulfur vulcanizing agent.

### CROSS-REFERENCE TO RELATED APPLICATIONS

This application is a continuation application of International Application number PCT/JP2021/000949, filed on Jan. 14, 2021, which claims the priority benefit of Japan Patent Application No. 2020-013806 filed on Jan. 30, 2020. The entirety of each of the above-mentioned patent applications are hereby incorporated by reference herein and made a part of this specification.

### BACKGROUND

### Technical Field

The present disclosure relates to a vibration isolation rubber composition and a vibration isolation rubber member used for vibration isolation applications in vehicles such as automobiles or trains.

### Background Art

In the technical field of vibration isolation rubber, there is a demand for low dynamic-to-static modulus ratios (reduction in values of dynamic-to-static modulus ratios [dynamic spring constant (Kd)/static spring constant (Ks)] to increase durability or improve quietness.

In addition, vibration isolation rubber is also required to have heat resistance in consideration of use in severely hot areas. In the related art, a diene rubber such as natural rubber is used in a polymer of vibration isolation rubber, and a sulfur vulcanizing agent is usually used as a vulcanizing agent thereof. However, such vibration isolation rubber has a problem with heat resistance. Therefore, it is known that an acrylic acid monomer be contained in a material of the vibration isolation rubber to cope with the above-described problem (refer to Patent Literature 1).

However, if the acrylic acid monomer is incorporated as described above, a vulcanization gas is likely to be generated. Therefore, foaming marks are likely to be generated in the vibration isolation rubber. If such foaming marks are generated, a problem may arise in that cracking is likely to proceed with the foaming marks as a starting point during long term use of of vibration isolation rubber. For this reason, it is difficult to improve the heat resistance while maintaining high durability and a low dynamic-to-static modulus ratio.

Therefore, the present applicant has already developed a technique of adding an acrylic acid monomer and an adsorption filler such as hydrotalcite to a material of vibration isolation rubber to solve the above-described problem due to a vulcanization gas (Patent Literature 2).

### CITATION LIST

### Patent Literature

### [Patent Literature 1]

PCT International Publication No. WO 2011/016545

### [Patent Literature 2]

Japanese Patent No. 5568493

However, since it cannot be said that the vibration isolation rubber disclosed in Patent Literature 2 exhibits sufficient performance regarding low dynamic-to-static modulus ratio, the present applicant has conducted further studies in response to market demands in recent years to further enhance properties required for vibration isolation rubber such as high durability, a low dynamic-to-static modulus ratio, and heat resistance.

The present disclosure has been made in consideration of the above-described circumstances and provides a vibration isolation rubber composition and a vibration isolation rubber member that can achieve both heat resistance and a low dynamic-to-static modulus ratio without impairing durability.

### SUMMARY

The present inventors have conducted extensive studies to solve the above-described problem. In the process of the research, a technique of enhancing the effect of expelling a vulcanization gas from a rubber composition by increasing the cross-linking density of a polymer being performed instead of the technique in the related art in which generation of a vulcanization gas is suppressed using an adsorption filler has been studied. That is, the above-described foaming marks being prevented from being generated by enhancing the effect of forcibly expelling a gas generated during vulcanization by increasing the cross-linking density of a polymer has been studied. Moreover, as a result of repeating various experiments, it has been found that a dihydrazide compound is effective as an additive having such an excellent effect regarding expelling a vulcanization gas by increasing the cross-linking density of a polymer and foaming marks which themselves become a starting point of cracks can be removed. The effect of suppressing the progress of cracks can also be obtained even in a case where a monohydrazide compound is used. However, a dihydrazide compound causes a large effect regarding expelling a vulcanization gas because a dihydrazide compound has higher reactivity and the cross-linking density of a polymer can be increased therewith. Moreover, use of a dihydrazide compound improves dispersibility of a filler and promotes a low dynamic-to-static modulus ratio. Thus, with this technique, the generation of a vulcanization gas can be suppressed without adding an adsorption filler.

Furthermore, in the present disclosure, use of zinc (meth)acrylate can further enhance the heat resistance. Although zinc (meth)acrylate is more likely to generate vulcanization gas than in a case where other acrylic acid monomers are contained, the problem of foaming marks of vibration isolation rubber can be solved by the above-described technique. In addition, in a case where zinc oxide and a (meth)acrylic acid monomer in addition to zinc (meth)acrylate are contained, substantially the same effect as a case where zinc (meth)acrylate is contained can be obtained when kneading rubber. Therefore, the heat resistance can be further improved.

[1] to [7] below are the gist of the present disclosure.

[1] A vibration isolation rubber composition including: a polymer made of a component (A) below; and components (B) to (E) below, in which (A) is a diene rubber, (B) is a filler, (C) is a dihydrazide compound, (D) is any one of a (meth)acrylic acid monomer, zinc oxide, and zinc (meth)acrylate, and (E) is a sulfur vulcanizing agent.

[2] The vibration isolation rubber composition according to [1], in which the above-described dihydrazide compound (C) is a dihydrazide compound represented by General Formula (1).

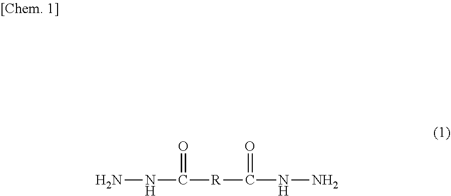

[In General Formula (1) above, R represents an alkylene group having 1 to 3 carbon atoms, a cycloalkylene group having 3 to 30 carbon atoms, or a phenylene group.]

[3] The vibration isolation rubber composition according to [1] or [2], in which a content ratio of the above-described dihydrazide compound (C) is within a range of 0.01 to 5.0 parts by weight based on 100 parts by weight of the above-described diene rubber (A).

[4] The vibration isolation rubber composition according to any one of [1] to [3], in which the above-described dihydrazide compound (C) is at least one selected from adipic acid dihydrazide and isophthalic acid dihydrazide.

[5] The vibration isolation rubber composition according to any one of [1] to [4], in which the above-described component (D) is zinc (meth)acrylate, and a weight ratio (C:D) between the above-described dihydrazide compound (C) and the zinc (meth)acrylate (D) is 100:1 to 10:100.

[6] The vibration isolation rubber composition according to any one of [1] to [5], in which a content ratio of the above-described filler (B) is within a range of 5 to 100 parts by weight based on 100 parts by weight of the above-described diene rubber (A).

[7] A vibration isolation rubber member including: a vulcanizate of the vibration isolation rubber composition according to any one of [1] to [6].

### DESCRIPTION OF THE EMBODIMENTS

From the above, with the vibration isolation rubber composition of the present disclosure, it is possible to achieve both heat resistance and a low dynamic-to-static modulus ratio at a high level without impairing durability.

Next, an embodiment of the present disclosure will be described in detail. However, the present disclosure is not limited to this embodiment.

The vibration isolation rubber composition of the present disclosure includes: the following components (B) to (E) together with a polymer made of a component (A) below.

(A) is a diene rubber.

(B) is a filler.

(C) is a dihydrazide compound.

(D) is any one of a (meth)acrylic acid monomer, zinc oxide, and zinc (meth)acrylate.

(E) is a sulfur vulcanizing agent.

### [Diene Rubber (A)]

As described above, a polymer made of a diene rubber (A) is used in the vibration isolation rubber composition of the present disclosure. The “polymer made of a diene rubber (A)” in the present disclosure refers to a polymer substantially made of only a diene rubber (A), and it is intended to include a “polymer made of only a diene rubber (A)”. For this reason, it is desirable that a polymer other than the diene rubber (A) be not used in the present disclosure. A diene rubber containing natural rubber (NR) as a main component is preferably used as the above-described diene rubber (A). Here, the “main component” means that 50 weight % or more of the above-described diene rubber (A) is natural rubber, and it is also intended that the above-described diene rubber (A) may be composed of only natural rubber. In this manner, when natural rubber is used as a main component, an excellent diene rubber is obtained in terms of strength or a low dynamic-to-static modulus ratio.

In addition, examples of diene rubbers other than natural rubber include butadiene rubber (BR), styrene-butadiene rubber (SBR), isoprene rubber (IR), acrylonitrile-butadiene rubber (NBR), ethylene-propylene-diene rubber (EPDM), butyl rubber (IIR), and chloroprene rubber (CR). These are used alone or in combination of two or more thereof. It is desirable that these diene rubbers be used in combination with natural rubber. Among these, it is more preferable that natural rubber be used in combination with isoprene rubber.

### [Filler (B)]

As the above-described filler (B), carbon black, silica, calcium carbonate, and the like are used alone or in combination of two or more thereof. Of these, carbon black is preferable from the viewpoint of vibration properties. It is desirable that 50 weight % or more of the above-described filler (B) be carbon black, and it is more desirable that 90 weight % or more of the above-described filler (B) be carbon black.

As the above-described carbon black, various grades of carbon black such as SAF-grade carbon black, ISAF-grade carbon black, HAF-grade carbon black, MAF-grade carbon black, FEF-grade carbon black, GPF-grade carbon black, SRF-grade carbon black, FT-grade carbon black, and MT-grade carbon black are used, for example. These may be used alone or in combination of two or more thereof. Of these, FEF-grade carbon black is preferably used from the viewpoints of vibration properties and fatigue resistance.

Moreover, the above-described carbon black preferably has an iodine adsorption amount of 10 to 110 mg/g and a DBP oil absorption amount (dibutylphthalate oil absorption amount) of 20 to 180 mL/100 g from the viewpoints of the durability and the low dynamic-to-static modulus ratio. The iodine adsorption amount of the above-described carbon black is a value measured according to JIS K 6217-1 (method A). In addition, the DBP oil absorption amount of the above-described carbon black is a value measured according to JIS K 6217-4.

As the above-described silica, wet silica, dry silica, and colloidal silica are used, for example. Moreover, these may be used alone or in combination of two or more thereof.

The BET specific surface area of the above-described silica is preferably 50 to 320 m²/g and more preferably 70 to 230 m²/g from the viewpoint of achieving higher durability, a lower dynamic-to-static modulus ratio, or the like.

The BET specific surface area of the above-described silica can be measured, for example, with a BET specific surface area measurement device (manufactured by Microdata, 4232-II) using a mixed gas (N₂: 70%, He: 30%) as an adsorbed gas after subjecting a sample to deaeration at 200° C. for 15 minutes.

Moreover, the total content of the above-described filler (B) based on 100 parts by weight of the diene rubber (A) is preferably within a range of 5 to 100 parts by weight, more preferably within a range of 10 to 80 parts by weight, and still more preferably within a range of 15 to 75 parts by weight from the viewpoint of the fatigue resistance.

### [Dihydrazide Compound (C)]

A dihydrazide compound represented by General Formula (1) below is preferably used as the above-described dihydrazide compound (C) because in this case increase in the dynamic-to-static modulus ratio can be effectively suppressed.

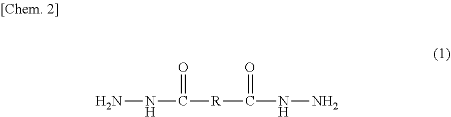

[In General Formula (1) above, R represents an alkylene group having 1 to 3 carbon atoms, a cycloalkylene group having 3 to 30 carbon atoms, or a phenylene group.]

In General Formula (1) above, R is preferably an alkylene group having 4 to 12 carbon atoms or a phenylene group.

Specific examples of the above-described dihydrazide compound (C) include adipic acid dihydrazide, isophthalic acid dihydrazide, phthalic acid dihydrazide, terephthalic acid dihydrazide, succinic acid dihydrazide, azelaic acid dihydrazide, sebacic acid dihydrazide, oxalic acid dihydrazide, and dodecanoic acid dihydrazide. These may be used alone or in combination of two or more thereof. Of these, adipic acid dihydrazide and isophthalic acid dihydrazide are preferable from the viewpoint of the low dynamic-to-static modulus ratio.

The content of the above-described dihydrazide compound (C) based on 100 parts by weight of the diene rubber (A) is within a range of, preferably 0.01 to 5.0 parts by weight, more preferably 0.1 to 5.0 parts by weight, and still more preferably 0.3 to 3.0 parts by weight from the viewpoint of a low dynamic-to-static modulus ratio or the like.

### [Any One of (Meth)Acrylic Acid Monomer, Zinc Oxide, and Zinc (Meth)Acrylate]

“(Meth)acrylic acid” in the present disclosure means acrylic acid or methacrylic acid.

In a case where a (meth)acrylic acid monomer and zinc oxide are used in combination as the above-described components (D), metal compounds are preferably excluded as the (meth)acrylic acid monomer, and examples of (meth)acrylic acid monomers include 2-tert-butyl-4-methyl-6-(2-hydroxy-3-tert-butyl-5-methylbenzyl)phenyl acrylate, nonylphenoxy polyethylene glycol acrylate, stearyl methacrylate, tridecyl methacrylate, polypropylene glycol monomethacrylate, phenoxy polyethylene glycol acrylate, N-acryloyloxyethyl hexahydrophthalimide, isobornyl methacrylate, tetrahydrofurfuryl acrylate, 2-phenoxyethyl methacrylate, ethoxylated (2)-hydroxyethyl methacrylate, and isodecyl methacrylate. These may be used alone or in combination of two or more thereof.

In addition, in a case where zinc (meth)acrylate is used as the above-described component (D), examples thereof include zinc monoacrylate, zinc dimethacrylate, and zinc diacrylate.

These may be used alone or in combination of two or more thereof.

In a case where a (meth)acrylic acid monomer and zinc oxide are used in combination as the above-described component (D), the content of the (meth)acrylic acid monomer based on 100 parts by weight of the diene rubber (A) is within a range of, preferably 0.5 to 10.0 parts by weight and more preferably 1.0 to 80 parts by weight from the viewpoint of the heat resistance or the like, and the content of zinc oxide based on 100 parts by weight of the diene rubber (A) is within a range of, preferably 1.0 to 20 parts by weight and more preferably 3.0 to 10 parts by weight from the viewpoint of a cross-linking reaction or the like.

In addition, in a case where zinc (meth)acrylate is used alone as the above-described component (D), the content thereof based on 100 parts by weight of the diene rubber (A) is preferably 0.3 to 10.0 parts by weight, more preferably 0.3 to 5.0 parts by weight, and still more preferably within a range of 1.0 to 5.0 parts by weight from the viewpoint of the heat resistance or the like.

Furthermore, in a case where the above-described component (D) is zinc (meth)acrylate, the weight ratio (C:D) of the above-described dihydrazide compound (C) to the zinc (meth)acrylate (D) is preferably 100:1 to 10:100, more preferably 20:1 to 10:100, and particularly preferably 10:10 to 10:100 from the viewpoint of the dynamic-to-static modulus ratio.

### [Sulfur Vulcanizing Agent (E)]

Examples of the above-described sulfur vulcanizing agent (E) include sulfur (powdered sulfur, precipitated sulfur, or insoluble sulfur) and sulfur-containing compounds such as alkylphenol disulfides. These may be used alone or in combination of two or more thereof.

In addition, the content of the above-described sulfur vulcanizing agent (E) based on 100 parts by weight of the diene rubber (A) is preferably within a range of 0.1 to 10 parts by weight and particularly preferably within a range of 0.3 to 5 parts by weight. That is, if the content of the above-described sulfur vulcanizing agent (E) is too small, the vulcanization reactivity tends to deteriorate. Conversely, if the content of the above-described sulfur vulcanizing agent (E) is too large, the physical properties (rupture strength and elongation at break) of rubber tend to deteriorate.

A silane coupling agent, a vulcanization accelerator, a vulcanization aid, an antiaging agent, a process oil, and the like can be appropriately contained in the vibration isolation rubber composition of the present disclosure as necessary together with the components (A) to (E) which are essential components of the vibration isolation rubber composition.

As the above-described silane coupling agent, a mercapto-based silane coupling agent, a sulfide-based silane coupling agent, an amine-based silane coupling agent, an epoxy-based silane coupling agent, and a vinyl-based silane coupling agent are used alone or in combination of two or more thereof, for example. Of these, a mercapto-based silane coupling agent or a sulfide-based silane coupling agent is preferable as the above-described silane coupling agent because in this case the vulcanization density is increased and these are particularly effective for obtaining a low dynamic-to-static modulus ratio and durability.

Examples of the above-described mercapto-based silane coupling agent include 3-mercaptopropyltrimethoxysilane and 3-mercaptopropyltriethoxysilane. These may be used alone or in combination of two or more thereof.

Examples of the above-described sulfide-based silane coupling agent include bis-(3-(triethoxysilyl)-propyl)-disulfide, bis(3-triethoxysilylpropyl) trisulfide, bis-(3-(triethoxysilyl)-propyl)-tetrasulfide, bis(3-trimethoxysilylpropyl) disulfide, bis(2-triethoxysilylethyl) tetrasulfide, bis(2-trimethoxysilylethyl) tetrasulfide, bis(3-triethoxysilylpropyl) disulfide, 3-trimethoxysilylpropyl-N,N-dimethylthiocarbamoyl tetrasulfide, 3-triethoxysilylpropyl-N,N-dimethylthiocarbamoyl tetrasulfide, 2-triethoxysilylethyl-N,N-dimethylthiocarbamoyl tetrasulfide, 2-trimethoxysilylethyl-N,N-dimethylthiocarbamoyl tetrasulfide, 3-trimethoxysilylpropyl benzothiazolyl tetrasulfide, 3-triethoxysilylpropyl benzothiazole tetrasulfide, 3-triethoxysilylpropyl methacrylate monosulfide, and 3-trimethoxysilylpropyl methacrylate monosulfide. These may be used alone or in combination of two or more thereof.

Examples of the above-described amine-based silane coupling agent include 3-aminopropyltriethoxysilane, 3-aminopropyltrimethoxysilane, N-(2-aminoethyl)-3-aminopropyltrimethoxysilane, N-(2-aminoethyl)-3-aminopropylmethyldimethoxysilane, and 3-(N-phenyl) aminopropyltrimethoxysilane. These may be used alone or in combination of two or more thereof.

Examples of the above-described epoxy-based silane coupling agent include 2-(3,4-epoxycyclohexyl)ethyltrimethoxysilane, 3-glycidoxypropyltrimethoxysilane, 3-glycidoxypropylmethyldiethoxysilane, 3-glycidoxypropyltriethoxysilane, and 3-glycidoxypropylmethyldimethoxysilane. These may be used alone or in combination of two or more thereof.

Examples of the above-described vinyl-based silane coupling agent include vinyltriethoxysilane, vinyltrimethoxysilane, vinyl-tris(β-methoxyethoxy)silane, vinyldimethylchlorosilane, vinyltrichlorosilane, vinyltriisopropoxysilane, and vinyl-tris(2-methoxyethoxy)silane. These may be used alone or in combination of two or more thereof.

The content of these silane coupling agents based on 100 parts by weight of the diene rubber (A) is preferably 0.5 to 20 parts by weight and more preferably 1.0 to 10 parts by weight from the viewpoints of an excellent low dynamic-to-static modulus ratio, excellent durability, and the like.

Examples of the above-described vulcanization accelerator include a thiazole-based vulcanization accelerator, a sulfenamide-based vulcanization accelerator, a thiuram-based vulcanization accelerator, an aldehyde-ammonia-based vulcanization accelerator, an aldehyde-amine-based vulcanization accelerator, a guanidine-based vulcanization accelerator, and a thiourea-based vulcanization accelerator. These may be used alone or in combination of two or more thereof. Among these, a sulfenamide-based vulcanization accelerator is preferable from the viewpoint of excellent crosslinking reactivity.

In addition, the content of the above-described vulcanization accelerators based on 100 parts by weight of the diene rubber (A) is preferably within a range of 0.1 to 10 parts by weight and particularly preferably within a range of 0.3 to 5 parts by weight.

Examples of the above-described thiazole-based vulcanization accelerator include dibenzothiazyl disulfide (MBTS), 2-mercaptobenzothiazole (MBT), 2-mercaptobenzothiazole sodium salt (NaMBT), and 2-mercaptobenzothiazole zinc salt (ZnMBT). These may be used alone or in combination of two or more thereof.

Examples of the above-described sulfenamide-based vulcanization accelerator include N-oxydiethylene-2-benzothiazolyl sulfenamide (NOBS), N-cyclohexyl-2-benzothiazolyl sulfenamide (CBS), N-t-butyl-2-benzothiazoyl sulfenamide (BBS), and N,N′-dicyclohexyl-2-benzothiazoyl sulfenamide. These may be used alone or in combination of two or more thereof.

Examples of the above-described thiuram-based vulcanization accelerator include tetramethylthiuram disulfide (TMTD), tetraethylthiuram disulfide (TETD), tetrabutylthiuram disulfide (TBTD), tetrakis(2-ethylhexyl)thiuram disulfide (TOT), and tetrabenzyl thiuram disulfide (TBzTD). These may be used alone or in combination of two or more thereof.

Examples of the above-described vulcanization aid include stearic acid and magnesium oxide. These may be used alone or in combination of two or more thereof.

In addition, the content of the above-described vulcanization aids based on 100 parts by weight of the diene rubber (A) is preferably within a range of 0.1 to 10 parts by weight and particularly preferably within a range of 0.3 to 7 parts by weight.

Examples of the above-described antiaging agent include a carbamate-based antiaging agent, a phenylenediamine-based antiaging agent, a phenol-based antiaging agent, a diphenylamine-based antiaging agent, a quinoline-based antiaging agent, an imidazole-based antiaging agent, and waxes. These may be used alone or in combination of two or more thereof.

In addition, the content of the above-described antiaging agents based on 100 parts by weight of the diene rubber (A) is preferably within a range of 0.5 to 15 parts by weight and particularly preferably within a range of 1 to 10 parts by weight.

Examples of the above-described process oil include a naphthenic oil, a paraffinic oil, and an aromatic oil. These may be used alone or in combination of two or more thereof.

In addition, the content of the above-described process oils based on 100 parts by weight of the diene rubber (A) is preferably within a range of 1 to 35 parts by weight and particularly preferably within a range of 3 to 30 parts by weight.

### [Method for Preparing Vibration Isolation Rubber Composition]

Here, the vibration isolation rubber composition of the present disclosure can be prepared by kneading the components (A) to (E) which are essential components thereof and, as necessary, other materials listed above using a kneading machine such as a kneader, a Banbury mixer, an open roll, or a twin-screw stirrer. In particular, it is preferable that all materials except a vulcanizing agent and a vulcanization accelerator be kneaded at the same time, and then the vulcanizing agent and the vulcanization accelerator be added thereto.

The thus obtained vibration isolation rubber composition of the present disclosure can be molded at a high temperature (150° C. to 170° C.) for 5 to 30 minutes through injection molding to produce a target vibration isolation rubber member (vulcanizate).

The vibration isolation rubber member composed of the vulcanizate of the vibration isolation rubber composition of the present disclosure is preferably used as a constituent member of an engine mount, a stabilizer bush, a suspension bush, a motor mount, a subframe mount, or the like used in automobile vehicles or the like. Among these, the vibration isolation rubber composition can be advantageously used for constituent members (vibration isolation rubber members for electric vehicles) of motor mounts, suspension bushes, subframe mounts, and the like for electric vehicles (including fuel cell vehicles (FCV), plug-in hybrid vehicles (PHV), hybrid vehicles (HV), and the like in addition to electric vehicles (EV)) using an electric motor as a power source because it has excellent heat resistance and durability in addition to a low dynamic-to-static modulus ratio.

In addition to the above-described applications, the vibration isolation rubber composition can also be used for vibration control dampers for computer hard disks, vibration control dampers for general home appliances such as washing machines, vibration control walls for construction in the construction and housing fields, and vibration control devices and base isolators of vibration control dampers and the like.

### EXAMPLES

Next, examples will be described along with comparative examples. However, the present disclosure is not limited to these examples.

First, materials shown below were prepared prior to the examples and the comparative examples.

[NR]

Natural rubber

[IR]

Nipol IR2200 manufactured by Zeon Corporation

[BR]

Nipol 1220 manufactured by Zeon Corporation

[Zinc Oxide]

Zinc oxide Grade No. 2 (JIS) manufactured by Sakai Chemical Industry Co.,

Ltd.

[Stearic Acid]

STEARIN manufactured by NOF CORPORATION

[Antiaging Agent]

Antigen 6C manufactured by Sumitomo Chemical Co., Ltd.

[Carbon Black (i)] FEF-Grade carbon black (SEAST SO manufactured by Tokai Carbon Co., Ltd., iodine adsorption amount of 44 mg/g, DBP oil absorption amount of 115 mL/100 g)

[Carbon Black (ii)]

FT-Grade carbon black (Seast TA manufactured by Tokai Carbon Co., Ltd., BET specific surface area of 19 m²/g)

[Silica (i)]

Nipsil VN3 manufactured by Tosoh Silica Corporation, BET specific surface area of 200 m²/g

[Silica (ii)]

Nipsil ER manufactured by Tosoh Silica Corporation, BET specific surface area of 100 m²/g

[Process Oil]

Sunthene 410 manufactured by Japan Sun Oil Company, Ltd.

[(Meth)Acrylic Acid Monomer (i)]

Zinc (meth)acrylate (SR709 manufactured by Sartomer Company, Inc.)

[(Meth)Acrylic Acid Monomer (ii)]

2-tert-Butyl-4-methyl-6-(2-hydroxy-3-tert-butyl-5-methylbenzyl) phenyl acrylate (Sumilizer GM manufactured by Sumitomo Chemical Co., Ltd.)

[(Meth)Acrylic Acid Monomer (iii)]

Nonylphenoxy polyethylene glycol acrylate (Aronix M111 manufactured by Toagosei Co., Ltd.)

[Hydrazide Compound (i)]

Isophthalic acid dihydrazide (IDH) manufactured by Otsuka Chemical Co., Ltd.

[Hydrazide Compound (ii)]

Adipic acid dihydrazide (ADH) manufactured by Otsuka Chemical Co., Ltd.

[Hydrazide Compound (iii)]

3-Hydroxy-2-naphthoic acid hydrazide (HNH) manufactured by Otsuka Chemical Co., Ltd.

### [Silane Coupling Agent]

NXT Z45 manufactured by MOMENTIVE

### [Vulcanization Accelerator]

Sanceler CZ-G manufactured by Sanshin Chemical Industry Co., Ltd.

### [Sulfur]

Sulfur manufactured by Karuizawa Smelter

### Examples 1 to 14 and Comparative Examples 1 to 3

The above-described samples were incorporated at ratios shown in Tables 1 and 2 below and kneaded to prepare vibration isolation rubber compositions. The above-described kneading was performed such that the materials other than the vulcanizing agent (sulfur) and the vulcanization accelerator were first kneaded at 140° C. for 5 minutes using a Banbury mixer, and then the vulcanizing agent and vulcanization accelerator were incorporated thereinto and kneaded at 60° C. for 5 minutes using an open roll.

The thus obtained vibration isolation rubber compositions of the examples and the comparative examples were evaluated for the properties according to the following criteria. The results thereof are concurrently shown in Tables 1 and 2 below.

### <<Dynamic-to-Static Modulus Ratio>>

Each of the vibration isolation rubber compositions was press-molded (vulcanized) under the condition of 160° C.×20 minutes to produce a test piece. Then, the static spring constant (Ks) of the above-described test piece was measured according to JIS K 6394. In addition, the storage spring constant (Kd100) of the above-described test piece at a frequency of 100 Hz was obtained according to JIS K 6385. Then, a value obtained by dividing the storage spring constant (Kd100) by the static spring constant (Ks) was regarded as a dynamic-to-static modulus ratio (Kd100/Ks).

Values obtained by converting the measurement values of the dynamic-to-static modulus ratios in the examples and the comparative examples according to an index in which the measurement value of the dynamic-to-static modulus ratio (Kd100/Ks) in Comparative Example 1 was set to 100 are shown in Tables 1 and 2 below. Further, when the value was less than 95% of the dynamic-to-static modulus ratio of Comparative Example 1, this was evaluated as “0”, and when the value was greater than or equal to 95%, this was evaluated as “x”.

### <<Heat Resistance>>

Each of the vibration isolation rubber compositions was press-molded (vulcanized) under the condition of 160° C.×20 minutes to produce a test piece. Then, the initial elongation at break (Eb) was measured in an atmosphere of 23° C. according to JIS K 6251. Next, the test piece produced above was allowed to stand in a high-temperature atmosphere of 100° C. for 70 hours (heat aging test), and then the elongation at break (Eb) was measured in the same manner as above. Then, the decrease rate (ΔEb) of the elongation at break after the heat aging test with respect to the initial elongation at break was calculated.

Then, when the value of the above-described decrease rate (ΔEb) in the heat resistance evaluation was less than 15%, this was evaluated as “0”, and when the value was greater than or equal to 15%, this was evaluated as “x”.

### <<Defoaming Properties>>

An unvulcanized rubber sheet (thickness of 12.5 mm) of each of the vibration isolation rubber compositions was punched into a cylindrical shape having a diameter of 28 mm to produce a sample, and the sample was heated (vulcanized without pressing) in an oven at 150° C. for 20 minutes.

Then, the appearance of the above-described sample or the foaming state of the cross section when the above-described sample was cut was visually evaluated. If significant foaming marks were observed in the above-described sample, this was evaluated as “x”. If some foaming marks were observed but did not interfere with actual use, this was evaluated as “Δ”. If no foaming marks were observed, this was evaluated as “◯”.

TABLE 1
(Parts by weight)

| | Examples | | | | | | | | | | | | | |
|---|---|---|---|---|---|---|---|---|---|---|---|---|---|---|
| | 1 | 2 | 3 | 4 | 5 | 6 | 7 | 8 | 9 | 10 | 11 | 12 | 13 | 14 |
| NR | 100 | 100 | 100 | 100 | 100 | 100 | 100 | 100 | 100 | 100 | 100 | 100 | 70 | 70 |
| IR | — | — | — | — | — | — | — | — | — | — | — | — | 30 | — |
| BR | — | — | — | — | — | — | — | — | — | — | — | — | — | 30 |
| Zinc oxide | 5 | 5 | 5 | 5 | 5 | 5 | 5 | 5 | 5 | 5 | 5 | 5 | 5 | 5 |
| Stearic acid | 2 | 2 | 2 | 2 | 2 | 2 | 2 | 2 | 2 | 2 | 2 | 2 | 2 | 2 |
| Antiaging agent | 1 | 1 | 1 | 1 | 1 | 1 | 1 | 1 | 1 | 1 | 1 | 1 | 1 | 1 |
| Carbon black (i) | 40 | 40 | 40 | 40 | 40 | 40 | — | — | — | 20 | 40 | 40 | 40 | 40 |
| Carbon black (ii) | — | — | — | — | — | — | 40 | — | — | — | — | — | — | — |
| Silica (i) | — | — | — | — | — | — | — | 40 | — | 20 | — | — | — | — |
| Silica (ii) | — | — | — | — | — | — | — | — | 40 | — | — | — | — | — |
| Process oil | 3 | 3 | 3 | 3 | 3 | 3 | 3 | 3 | 3 | 3 | 3 | 3 | 3 | 3 |
| (Meth)acrylic | 3 | 3 | 3 | 3 | 1 | 5 | 3 | 3 | 3 | 3 | — | — | 3 | 3 |
| acid monomer (i) | | | | | | | | | | | | | | |
| (Meth)acrylic | — | — | — | — | — | — | — | — | — | — | 3 | — | — | — |
| acid monomer (ii) | | | | | | | | | | | | | | |
| (Meth)acrylic | — | — | — | — | — | — | — | — | — | — | — | 3 | — | — |
| acid monomer (iii) | | | | | | | | | | | | | | |
| Hydrazide | — | — | — | 1 | — | — | — | — | — | — | — | — | — | — |
| compound (i) | | | | | | | | | | | | | | |
| Hydrazide | 1 | 0.3 | 3 | — | 1 | 1 | 1 | 1 | 1 | 1 | 1 | 1 | 1 | 1 |
| compound (ii) | | | | | | | | | | | | | | |
| Hydrazide | — | — | — | — | — | — | — | — | — | — | — | — | — | — |
| compound (iii) | | | | | | | | | | | | | | |
| Silane coupling | — | — | — | — | — | — | — | 1 | 1 | 1 | — | — | — | — |
| agent | | | | | | | | | | | | | | |
| Vulcanization | 1 | 1 | 1 | 1 | 1 | 1 | 1 | 1 | 1 | 1 | 1 | 1 | 1 | 1 |
| accelerator | | | | | | | | | | | | | | |
| Sulfur | 2.5 | 2.5 | 2.5 | 2.5 | 2.5 | 2.5 | 2.5 | 2.5 | 2.5 | 2.5 | 2.5 | 2.5 | 2.5 | 2.5 |
| Dynamic-to-static | 91 | 93 | 92 | 89 | 91 | 94 | 86 | 94 | 92 | 92 | 92 | 93 | 92 | 89 |
| modulus ratio | | | | | | | | | | | | | | |
| (index) | | | | | | | | | | | | | | |
| Evaluation | ∘ | ∘ | ∘ | ∘ | ∘ | ∘ | ∘ | ∘ | ∘ | ∘ | ∘ | ∘ | ∘ | ∘ |
| Heat resistance | 11 | 9 | 12 | 10 | 14 | 7 | 12 | 9 | 10 | 11 | 13 | 12 | 10 | 8 |
| (ΔEb(%)) | | | | | | | | | | | | | | |
| Evaluation | ∘ | ∘ | ∘ | ∘ | ∘ | ∘ | ∘ | ∘ | ∘ | ∘ | ∘ | ∘ | ∘ | ∘ |
| Defoaming | ∘ | ∘ | ∘ | ∘ | ∘ | ∘ | ∘ | ∘ | ∘ | ∘ | ∘ | ∘ | ∘ | ∘ |
| property | | | | | | | | | | | | | | |

TABLE 2
(Parts by weight)

| | Comparative Example | | |
|---|---|---|---|
| | 1 | 2 | 3 |
| NR | 100 | 100 | 100 |
| IR | — | — | — |
| BR | — | — | — |
| Zinc oxide | 5 | 5 | 5 |
| Stearic acid | 2 | 2 | 2 |
| Antiaging agent | 1 | 1 | 1 |
| Carbon black (i) | 40 | 40 | 40 |
| Carbon black (ii) | — | — | — |
| Silica (i) | — | — | — |
| Silica (ii) | — | — | — |
| Process oil | 3 | 3 | 3 |
| (Meth)acrylic acid monomer (i) | 3 | — | 3 |
| (Meth)acrylic acid monomer (ii) | — | — | — |
| (Meth)acrylic acid monomer (iii) | — | — | — |
| Hydrazide compound (i) | — | — | — |
| Hydrazide compound (ii) | — | 1 | — |
| Hydrazide compound (iii) | — | — | 1 |
| Silane coupling agent | — | — | — |
| Vulcanization accelerator | 1 | 1 | 1 |
| Sulfur | 2.5 | 2.5 | 2.5 |
| Dynamic-to-static modulus ratio (index) | 100 | 90 | 96 |
| Evaluation | x | ∘ | x |
| Heat resistance (ΔEb(%)) | 12 | 19 | 11 |
| Evaluation | ∘ | x | ∘ |
| Defoaming property | x | ∘ | Δ |

From the results of Tables 1 and 2 above, since no foaming mark was observed in the defoaming property evaluation for the vibration isolation rubber compositions of the examples, the durability was not impaired and the criteria for the heat resistance and the low dynamic-to-static modulus ratio were also met.

In contrast, since the vibration isolation rubber composition of Comparative Example 1 contained no dihydrazide compound, foaming marks due to zinc (meth)acrylate could not be eliminated. The vibration isolation rubber composition of Comparative Example 2 contained no (meth)acrylic acid monomer including zinc (meth)acrylate at all, and as a result, the heat resistance deteriorated. The vibration isolation rubber composition of Comparative Example 3 contained a monohydrazide compound (3-hydroxy-2-naphthoic acid hydrazide) but no dihydrazide compound, and as a result, the dynamic-to-static modulus ratio was higher than those of the examples and the vibration isolation rubber composition thereof was also inferior in the defoaming property evaluation.

In the above-described examples, the specific aspect of the present disclosure has been shown, but the above-described examples are merely examples and are not to be narrowly interpreted. Various modifications apparent to those skilled in the art are intended to be within the scope of the present disclosure.

### INDUSTRIAL APPLICABILITY

The vibration isolation rubber composition of the present disclosure can be preferably used as a material for constituent members (vibration isolation rubber members) of engine mounts, stabilizer bushes, suspension bushes, motor mounts, subframe mounts, and the like which are used in automobile vehicles or the like, but also can be used as materials for constituent members (vibration isolation rubber members) of vibration control dampers for computer hard disks, vibration control dampers for general home appliances such as washing machines, vibration control walls for construction in the construction and housing fields, and vibration control devices and base isolators of vibration control dampers and the like.

1. A vibration isolation rubber composition, comprising:
components (B) to (E) below together with a polymer made of component (A) below,
wherein (A) is a diene rubber, (B) is a filler, (C) is a dihydrazide compound, (D) is any one of a (meth)acrylic acid monomer, zinc oxide, and zinc (meth)acrylate, and (E) is a sulfur vulcanizing agent.

2. The vibration isolation rubber composition according to claim 1,
wherein the dihydrazide compound (C) is a dihydrazide compound represented by General Formula (1), 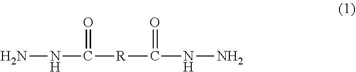
[in the General Formula (1), R represents an alkylene group having 1 to 3 carbon atoms, a cycloalkylene group having 3 to 30 carbon atoms, or a phenylene group.]

3. The vibration isolation rubber composition according to claim 1,
wherein a content ratio of the dihydrazide compound (C) is within a range of 0.01 to 5.0 parts by weight based on 100 parts by weight of the diene rubber (A).

4. The vibration isolation rubber composition according to claim 1,
wherein the dihydrazide compound (C) is at least one selected from adipic acid dihydrazide and isophthalic acid dihydrazide.

5. The vibration isolation rubber composition according to claim 1,
wherein the component (D) is zinc (meth)acrylate, and a weight ratio (C:D) of the dihydrazide compound (C) to the zinc (meth)acrylate (D) is 100:1 to 10:100.

6. The vibration isolation rubber composition according to claim 1,
wherein a content ratio of the filler (B) is within a range of 5 to 100 parts by weight based on 100 parts by weight of the diene rubber (A).

7. A vibration isolation rubber member, comprising:
a vulcanizate of the vibration isolation rubber composition according to claim 1.
